(19) United States
(12) Patent Application Publication
(10) Pub. No.: US 2014/0190476 A1
(43) Pub. Date: Jul. 10, 2014

(54) SEAL FOR FULL FACE MASK

(71) Applicant: Diving Unlimited International, Inc., (US)

(72) Inventor: Robert T. Stinton, San Diego, CA (US)

(73) Assignee: DIVING UNLIMITED INTERNATIONAL, INC., San Diego, CA (US)

(21) Appl. No.: 13/760,989

(22) Filed: Feb. 6, 2013

Related U.S. Application Data
(60) Provisional application No. 61/596,017, filed on Feb. 7, 2012.

(51) Int. Cl. A62B 17/04

(52) U.S. Cl. CPC A62B 17/04
USPC 128/201.23

(57) ABSTRACT

The outer periphery of a face mask has a first ribbed seal member located on an outward facing surface of the mask and configured to mate with a second ribbed seal member located on an inward facing surface of a periphery of a face opening in a hood that fits over the user's head during use. The ribbed seal members mate to form fluid tight seal. A skirt is connected to the mask and extends around the outer periphery and along a portion of the inside surface of the mask in order to form a contact seal with the user's head during use.

### CROSS-REFERENCE TO RELATED APPLICATIONS

This application claims the benefit under 35 U.S.C. 119(e) to Provisional Patent Application No. 61/596,017 filed Feb. 7, 2012, the entire contents of which are incorporated herein by reference.

### STATEMENT RE: FEDERALLY SPONSORED RESEARCH/DEVELOPMENT

Not Applicable

### BACKGROUND

Hazardous environments include those that do not support the safe and normal respiration, thus creating inhalation hazards. These inhalation hazards typically come from three primary groups: Gaseous environment containing CBRN (Chemical Biological, Radiological, Nuclear) agents and/or hypoxic or anoxic conditions. The most extreme terrestrial environment involve liquid environments. Even in a non CBRN contaminated liquid environment those entering the environment, such as underwater “divers,” require respiratory protection. This liquid environment is made more complex when CBRN contaminates are present. Individuals operating in these environments often come from three primary groups, public safety, industrial and scientific.

In the gaseous environments face shields devices are used, such as the Interspiro Spiromatic Face-piece which covers the individuals face (eyes, nose and mouth) forming a seal protecting the face from exposure to the outside environment. FIG. 1 shows an Interspiro Spiromatic Face-piece, FIG. 2 shows an Interspiro Spiromatic equipped with an Interspiro demand Self Contained Breathing Apparatus Regulator (SCBA).

In terrestrial hazardous environments The National Institute for Occupational Safety and Health (NIOSH), along with the U.S. Army Soldier Biological and Chemical Command (SBCCOM), and the National Institute for Standards and Technology (NIST) develop appropriate standards and test procedures for all classes of respirators that provide respiratory protection from CBRN inhalation hazards. The classes include:

(1) Air-Purifying Escape Respirator (APER) with CBRN Protection (Uses breath powered filtration device);

(2) Air-Purifying Respirator (APR) with CBRN Protection (Use breath powered filtration device);

(3) Powered-Air-Purifying Respirators (PAPR) with CBRN Protection (Use power assisted filtration device); and

(4) Self-Contained Breathing Apparatus (SCBA) with CBRN Protection (Uses umbilical or individual carried compressed air, or oxygen, or cryogenic stored breathing gas.)

There are also several U.S. Levels of Protection, generally described as follows:

Level A: The highest level of protection against vapors, gases, mists, and particles is Level A, which consists of a fully encapsulating chemical entry suit with a full-face-piece self-contained breathing apparatus (SCBA) or a supplied air respirator (SAR) with an escape cylinder. A crew member must also wear boots with steel toes and shanks on the outside of the suit and specially selected chemical-resistant gloves for this level of protection. The breathing apparatus is worn inside (encapsulated within) the suit. To qualify as Level A protection, an intrinsically safe two-way radio is also worn inside the suit, often incorporating voice-operated microphones and an earpiece speaker for monitoring the operations channel.

Level B: The protection Level B requires a garment (including SCBA) that provides protection against splashes from a hazardous chemical. Since the breathing apparatus is worn on the outside of the garment, Level B protection is not vapor-protective. It is worn when vapor-protective clothing (Level A) is not required. Wrists, ankles, face-piece and hood, and waist are secured to prevent any entry of splashed liquid. Depending on the chemical being handled, specific types of gloves and boots are donned. These may or may not be attached to the garment. The garment itself may be one piece or a two-piece hooded suit. Level B protection also requires the wearing of chemical-resistant boots with steel toes and shanks on the outside of the garment. As with Level A, chemical-resistant gloves and two-way radio communications are also required.

In the liquid environments no standards or test procedures exist outside that of the U.S. Navy which developed standards and test methods for test diving equipment to address the needs of the Navy. The following description addresses the most environments discussed above liquid (diving) environment. However, the following disclosed approach for a mask personal protective garment interface is also applicable to the aforementioned protective systems when used in level A and B environments and providing a higher level of splash or (gas, vapor or droplet) protection.

In the diving environment the full face Mask used is not that much different in concept than the Scott SV3000 (FIG. 1) and Scott SCBA Demand Regulator (FIG. 2) combination. An example of a diving mask is the Interspiro DIVATOR II diver's full face mask shown in FIG. 3.

A full face Mask protects the individual's face and eyes and provides respiratory protection while operating in hazardous environments. As shown in FIGS. 1-3, underwater divers' use a full face mask for two primary reasons, namely to facilitate voice communication or to protect the face from the environment. In either application, a head harness pulls the face mask against the user's face so that a skirt around the mask forms a contact seal with the user's face. Further, the full face mask encloses or has built-in an oral-nasal mask that has its own skirt forming a separate seal around the user's mouth and nose to increase the air supply to the user and remove the exhaled breath.

The most common environmental factor for divers is cold water. However in some diving operations such as commercial, public safety, and military diving a full face mask may be used in combination with a dry suit to protect the user from water born contaminates. The contaminates encountered can range from biological, chemical and radiological to possible combinations thereof. The dry suit or protective garment isolates the individual's body from exposure while the full face mask isolates the user's face and respiratory track while allowing visibility and breathing. The dry suits typically cover the user's entire body and may include built-in or removable gloves and built-in or removable foot coverings. The dry suits may be a single piece garment with a sealed zipper down the front, or a sealed zipper down the back, or a sealed across the shoulder and angling toward or past the user's hip or thigh.

The full face mask is a separate part from the dry suit and usually has a generally rectangular or oval opening covered by acrylic or transparent plastic which is sealed to the mask and though which the user looks during use. A typical diver's full face mask is held onto and sealed against a person's head as shown in FIGS. 1-3 by a head harness which may be adjustable length but relatively inelastic straps, or by elastic straps. The full face mask has from three to six connector points connected to straps that encircle a portion of a person's head which is enclosed in a hood, and hold the mask against the hood to form a seal with the hood. The hood may be a unitary part of the dry suit, or a separate part that is releasably sealed to the dry suit. A respirator fits underneath or through the full face mask with at least a portion passing through the mask to provide air or selected gases to the oral-nasal breathing mask enclosed within the full face mask or formed as part of the face mask.

The skirt of the full face mask forms a friction or contact seal between mask skirt and the hood of the protective garment worn by the user. The integrity of this friction or contact seal is maintained solely by the holding force of the head harness. This holding force is low and there is always a risk of the mask being dislodged and the seal compromised. In surface use applications this risk is mitigated by maintaining the pressure in the mask slightly above ambient pressure (2-3 inches of water) in the belief that if the seal between the mask and the user is compromised air will vent form the inside of the mask because of the positive pressure and thereby keeping contaminates out of the mask. In short, the theory is that contaminants do not flow upstream against the positive air pressure. The efficacy of this logic is uncertain, in part because any positive pressure inside the mask has a tendency to push the mask of the user off the user face and potentially compromising the seal. The positive internal pressure also reduces the sealing force of the external air pressure, making leakage more likely. Further, the rate at which a gap between the mask and user forms and the size of the gap both affect the relative, localized pressure at the gap thus causing uncertainty as to how much positive pressure is desirable while still keeping the mask on the user's face.

While this internal positive mask pressure may work in surface applications it poses problems in underwater environments. In the underwater environment the risk of dislodging the mask and breaking the seal is higher because of low light, low to no visibility, water resistance to movement, surge and other physical factors not commonly experienced in air. Also, as the depth increases the internal pressure needs to increases to offset some of the ambient surrounding water pressure. But because the increased density of the water the pressure gradient across the mask from the diver's chin to the forehead can be about 8-10 inches of water. The result is that a positive pressure of 2-3 inches of water inside the mask is ineffective in some positions that the diver may assume underwater, resulting in inadequate sealing pressure along portions of the mask skirt during use.

These prior art seals effectively provide a friction seal against the hood placed over the user's head. But the friction seals can leak as the friction changes from any of a variety of causes, some of which are noted above. As further examples, any distortion to the full face mask caused by the weight or movement of the respirator or breathing mask risks distorting the seal between the mask and the hood and that risks leakage. Leakage is not desirable in hazardous environments. There is thus a need for an improved seal for a full face mask.

### BRIEF SUMMARY

The outer periphery of a face mask has a first ribbed seal located on an outward facing surface of the mask. That first seal member is configured to mate with a second ribbed seal member located on an inward facing surface of a periphery of a face opening in a hood that fits over the user's head during use. The seal members mate to form a gas or fluid tight seal. A flexible skirt is connected to the face mask and extends around the outer periphery of the mask and along a portion of the inside surface of the mask in order to form a contact seal with the user's head during use. A head harness connects to the mask and pulls or urges the mask against the user's head.

In more detail, a face mask assembly is provided that includes a facemask having a body portion with an outer periphery shaped to abut and conform to a user's head or a hood covering that head. The body portion has a viewing visor or viewing port and during use has a head harness to hold the mask against the user's head or hood. The face mask assembly includes a first ribbed seal member connected to and extending completely around the outer periphery of the mask. The first ribbed seal member is located on an outward facing surface of the mask. A first flexible skirt is connected to the mask and extends completely around the outer periphery of the mask. The first skirt extends along a portion of the inside surface of the mask during use and is configured to form a contact seal or friction seal with the user's head or hood when the harness is sufficiently tightened during use of the mask. The assembly also includes at least two connectors on the mask configured to connect the mask to the harness during use of the mask. The connectors may be located on the outer surface of the mask and between the ribbed seal member and the viewing visor or port. The harness may be located inside the hood or on the outside of the hood.

In further variations, the assembly may optionally include a full face mask with a top, two opposing sides and a bottom, with the bottom being configured and located relative to the top to abut a user's neck during use. The assembly with the full face mask may also include an oral-nasal mask contained at least partially within the full face mask. The oral-nasal mask preferably has a second flexible skirt around a periphery of the oral-nasal mask with the second skirt extending along an inside portion of the oral-nasal mask and being configured to form a contact seal with the user's face during use.

The above assemblies may also include a flexible hood configured to fit over and generally conform to the shape of the user's head and neck during use. The hood has a face opening with a second ribbed seal member extending completely around a periphery of the face opening. The second ribbed seal member is located on an inward facing surface of the hood and is sized and configured and located to mate with the first seal member to form a fluid tight seal. In the above ribbed seal members, the seal members preferably have two or three hooked ribs, but may have more.

There is also provided an assembly for use with a facemask. This assembly includes a flexible hood configured to conform to and fit over the user's head during use. The hood has a face opening with a periphery and a first ribbed seal member connected to the hood and extending completely around that periphery of the face opening. The first seal member is on an inward facing surface of the hood.

In further variations, the face opening of this assembly has a top, opposing sides and a bottom opposite the top, with the top and bottom being sized and located relative to each other so that the top is at the user's forehead during use and the bottom is located at the user's neck. In this variation the hood is used with a full face mask as described above and hereinafter.

Alternatively, the face opening may have the top and bottom sized and located relative to each other so that the top is at the user's forehead during use and the bottom is located to fit between the user's nose and mouth during use. In this variation, the hood is used with a partial face mask as described above and hereinafter.

Preferably, in all of the above variations, the first and second seal members are joined together to form a gas and fluid tight seal. Moreover, the above described hoods may be used with a body suit that is sealingly connected to the hood. The body suit may enclose the user's body except the head and face, with the hood and face shield enclosing the head and face. As desired, gloves or boots may be removably sealed to the body suit, or be made a permanent part of the body suit.

### BRIEF DESCRIPTION OF THE DRAWINGS

These and other features and advantages of the hood and face mask will be better understood by reference to the following drawings in which like numbers refer to like parts throughout, and in which:

FIG. 1 is a perspective view of a prior art mask and respirator with a five point attachment to the mask holding the mask against the hood portion of a person's head;

FIG. 2 is a perspective view of a prior art HAZMAT suit showing suited personnel moving a barrel wearing the mask of FIG. 1;

FIG. 3 is a perspective view of underwater diver with a portable air supply wearing the mask of FIG. 1;

FIG. 4 is a perspective view of the outside of a full face mask with an opening for a breathing device and straps for a head harness;

FIG. 5 is a perspective view of a hood for use with the full face mask of FIG. 4;

FIG. 6 is a cross-sectional view of the mask of FIG. 4 on the profile of a user's face with the dashed lines showing the approximate contact seal area formed by a flexible skirt on the facemask;

FIG. 7 is a cross-sectional view of the mask of FIG. 4 and a hood both on the profile of a person's face with the hood shown spaced from the head;

FIG. 8a is a partial cross-sectional view of a hood seal;

FIG. 8b, is a partial cross-sectional view of a mask seal;

FIG. 8c is a partial cross-sectional view of the seals of FIGS. 8a and 8b in a mating and sealing configuration; and

FIG. 9 is a side view of a full face mask with a head harness inside a hood.

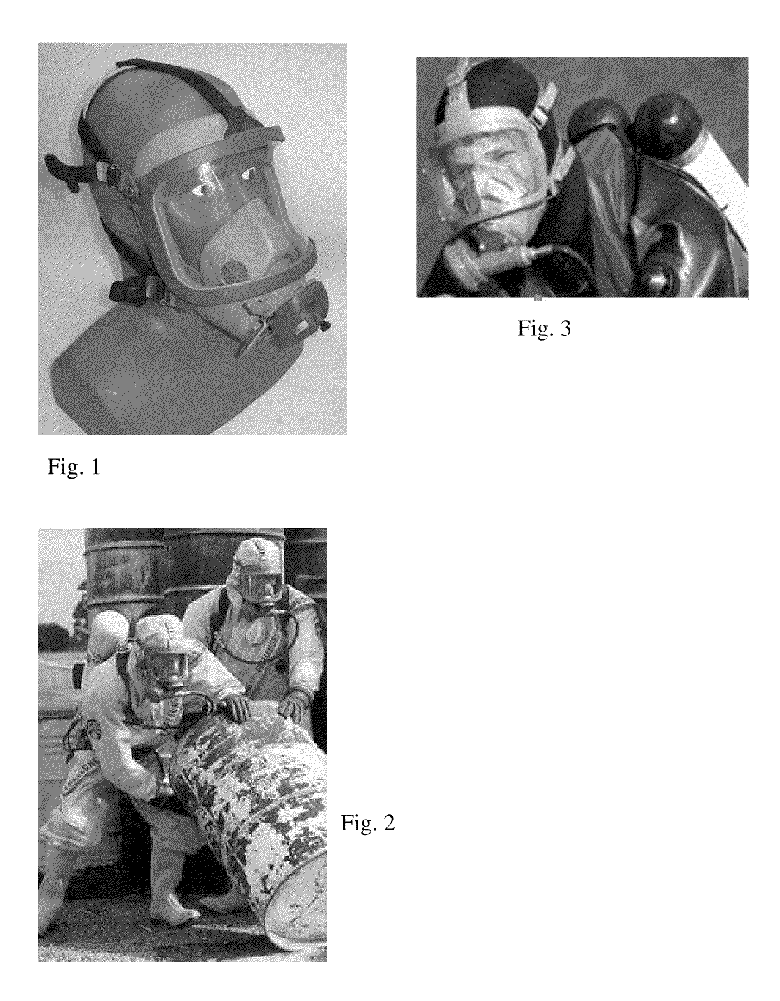

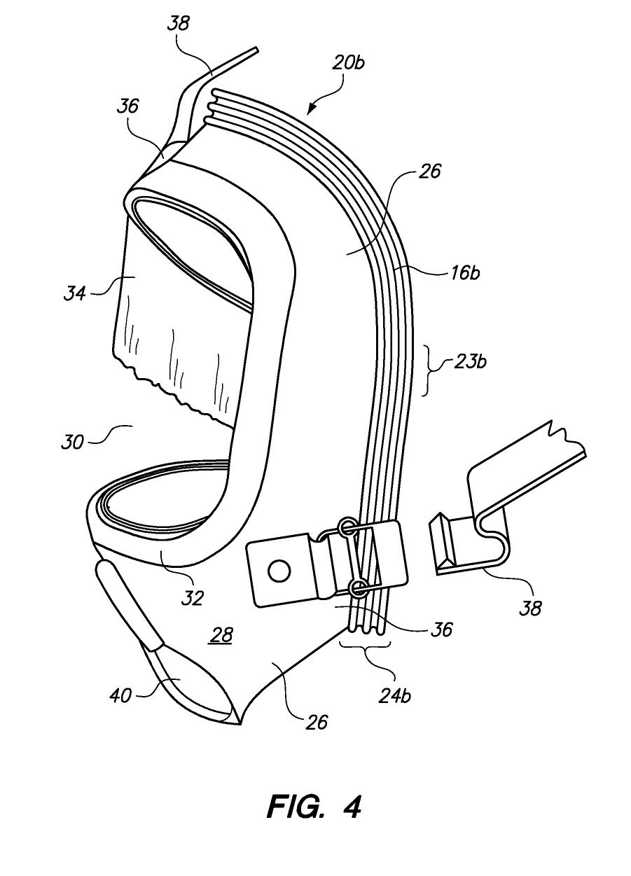

### DETAILED DESCRIPTION

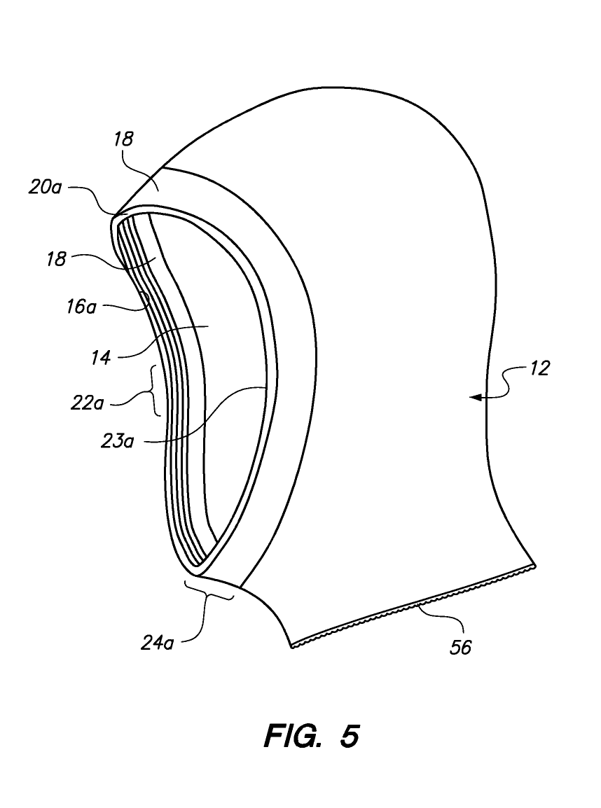

Referring to FIGS. 4-8, as used herein, forward refers to a direction toward which a user faces during use of the equipment described herein, and rearward or backward refers to the opposite direction. Up and down refer to the relative directions of a user standing on the ground. Top, bottom and sides refer to the relative directions of a user's face when the user is standing. Outward or outer refers to the direction away from a user's head or away from a specified part, with the direction varying with the orientation of the particular portion of the user's head in question. Inward or inner refers to the direction toward a user's head or toward another portion of a specified part. Unless noted otherwise, as used herein the term “fluid” includes both water, gases (including air), and vapor. The term “fluid tight seal” refers to a seal blocking the passage of water, gases and vapors atmospheric pressure, or slight variations thereon, including the variations experienced with current diving and HAZMAT masks. Referring to FIGS. 4a and 4b, 6 and 7, a user has a suit 10 with a hood 12 having a face opening 14 for the user's face. The hood 12 has a portion of a hood seal member 16a on the inside of the hood around the periphery of the face opening 14. The seal member 16a is preferably a portion of a ribbed seal. The seal portion 16a may advantageously be formed on or as part of a marginal strip of material 18a fastened around the periphery of the face opening 14 which is fastened to the material forming the hood 12. The seal portion 16a is preferably formed adjacent the edge of the hood or strip 18 forming the face opening 14 and advantageously completely encircles that face opening.

The hood 12 typically has an upper portion that extends over part of the user's forehead, forming a top portion 20 of the hood seal member 16a and defining the top portion of the face opening 14. The face opening 14 in the hood 12, and thus the hood seal 22a, has two opposing sides 22a, 23a that each pass from the user's forehead, along the user's temple and along the side of the user's face between the user's eye and ear, down to the user's jaw. The opening 14 and thus the hood seal 22a also has a bottom portion 24a that joins the two sides 22a, 23a and that typically extends underneath the user's jaw between the user's throat (or neck) and chin. When a user is standing upright, the sides 22a, 23a are generally vertical and in the same plane while the top portion 20a extends outward from that plane toward the user's nose or forehead, typically forming a generally U-shaped curve along the sides and front of the user's forehead. The bottom portion 24a is generally inclined toward the user's chin and away from the user's throat or neck. The face opening 14 mating with the seal member 16a is thus not planar during use and has the top 20a and bottom 24a portions extending in the same direction away from the plane formed by the sides 22a, 23a when not in use, the hood seal member 16a has a generally curved shape. The shape of the face opening 14 and seal member 16a can vary so that the opposing sides 22a, 23a have any desirable length from long to short, and thus the opening 14 and seal member 16a may have a curved shape when viewed from the side and when viewed from the front have a generally oval or round-cornered rectangular shape.

The hood seal member 16a forms a fluid tight seal with a mating face mask seal member 16b on the full face mask 26. The mask seal 16b is preferably a ribbed seal configured to sealing mate with hood seal 16a. Advantageously, the mask seal member 16b is located around a periphery of the full face mask 26. The full face mask 26 is configured and located to conform with the shape and location of the hood seal member 16a, and vice versa. Thus, the mask seal 16b and corresponding portions of the full face mask 26 have a top portion 20b, two side portions 22a, 23b and a bottom portion 26b. The shapes of the portions 20b, 22b, 23b, 24b are the same as the shapes 20a, 22a, 23a and 24a as they overlap and mate for form a fluid and gas tight seal during use. The mask seal member 16b is advantageously formed as part of a marginal strip 18b extending around the periphery of the face mask 26.

The face mask 26 has a body portion the outer periphery of which is preferably formed by seal member 16b. The mask seal member 16b is advantageously located on an outward facing surface of the mask 26 and extends outward from the face mask 26 in a direction generally away from the person's face along the length of the mask seal member 16b. The mask seal member 16b may extend over the peripheral edge of the mask body 28 and onto the inner facing surface at the face mask 26 in order to sandwich the body portion 26 between opposing layers of the marginal strip 18b. The body 26 is advantageously made of rubber of silicon, with a durometer of about 70 believed suitable for the body 26.

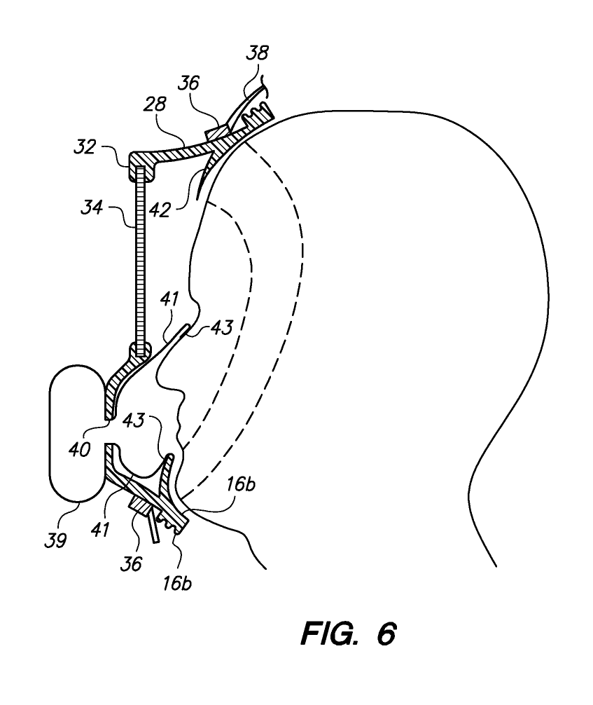

The full face mask 26 has a viewing opening 30 the periphery of which is surrounded by an outward extending flange 32 along the periphery of the viewing opening 30. A viewing visor (or viewing port) 34 is fastened to the flange by means known in the art that are suitable to form a fluid tight seal, including adhesives, thermal bonding, and mechanical sealing configurations. In the depicted embodiment of FIG. 6 only a portion of the visor 34 is shown in order to show a groove formed in the flange. The visor 34 is received in and sealingly fastened within that groove. But other fastening mechanisms can be used. The visor or port 34 is typically made of an acrylic plastic or other transparent or tinted material suitable for the particular use of the full face mask 26.

The visor opening 30 and flange 32 are preferably spaced apart from the mask seal member 16b a distance sufficient to allow connectors 36 to be fastened to the full face mask 26. The connectors 36 are like the prior art connectors used to connect to straps 38 of a head harness 37 with straps encircling the user's head or neck to hold the face mask 26 against the hood 12 during use. Thus, for a five point attachment there would usually be five connectors 26 on the face mask 26. The location and number of connectors 36 will vary with the type of strap configuration or head harness 37 used to hold the face mask to the user's head during use. From two to eight straps may be used, possibly more, with five being more common. The connectors 36 and straps 38 of the head harness 37 are believed optional, but are preferred for additional security.

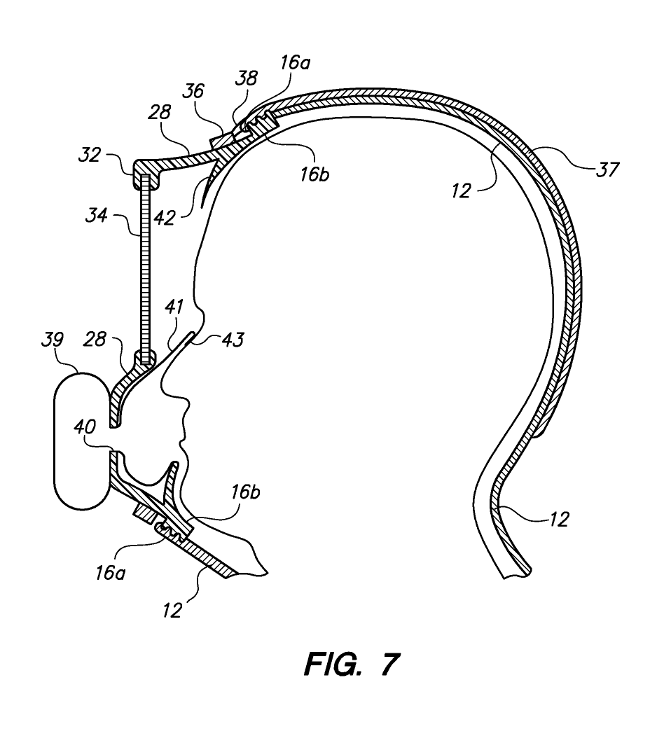

The face mask 26 also typically has a breathing access opening 40 in the lower portion of the mask, adjacent to or below the location of the user's mouth during use. Various breathing devices 39 may be fastened to the face mask 26 through the access opening 40. Depending on the manufacturer, the opening 40 may be located at or below the chin or in front of the mouth. Typical breathing devices 39 include air filtration devices or connectors to air sources such as portable compressed gas cylinders, self-contained close circuit breathing apparatus, or umbilical supplied compressed gas. The elected breathing device 39 is connected to the mask 26 in any of a variety of sealed connections known in the art or developed hereinafter. If desired, the breathing device 39 may include the oral-nasal breathing mask 41 located inside the complete face shield covering the nose and mouth of the user in order to achieve its primary purpose of supplying the breathing gas directly to the air intake organs of the user and reducing the mask CO₂ dead space. Such an oral-nasal mask 41 is shown in FIGS. 6-7, with flexible skirts configured and sized to be held to the user's face around the mouth and nose by a head harness 37 described later. An alternative to the oral nasal mask in a full face mask is a mouth piece similar to those used by underwater SCUBA. But the use of a mouthpiece hinders the use of communications.

The construction of the suit 10, hood 12, face mask 26 and seals 16a, 16b are preferably as described in U.S. Pat. No. 7,062,786, titled Garment With Releasable Water-Tight Seal For Neck And Limbs, the complete contents of which are incorporated herein by reference. The seals 16a, 16b are shown for convenience in FIG. 5.

The full face mask and the protective suit hood connected together form a more robust interlocking seal (FIG. 7) in combination with the traditional contact seal. Even in this more secure embodiment the head harness is still desirably used as part of the system. It is believed that this combination seal will make the mask-to-hood seal more positive and minimize the possibility of the mask being dislodged and the seal broken.

The releasable fluid-tight seal members 16a, 16b have complementary configurations for releasable interlocking to provide a fluid-tight seal between the parts 16a, 16b. The hood seal member 16a hood has a marginal strip portion fastened (e.g. molded, glued, thermally bonded or otherwise bonded) to the strip 18a and/or hood 12. The hood seal member 16a is thus a ribbed seal, and advantageously has one or more, and preferably two or three hook-shaped ribs 48a that define three channels therebetween. The face mask seal member 16b is also a ribbed seal, and advantageously has a construction configured to receive hood seal member 16a, and preferably, but optionally, is identical to that of the hood seal member 16a. The mask seal member 16b has a marginal strip portion that is fastened to the face mask 26. The mask seal member 16b has one or more, and preferably two or three hook-shaped ribs 48b that define channels therebetween. The ribs 48a and 48b are complementary to the channels so that they may releasably lock together to provide a sealing fit, preferably a slight interference fit. The hook shapes of the ribs 48a and 48b are undercut and that undercut hook helps ensure that the hooks they are retained within their corresponding channels and will not inadvertently release. But while hook-shaped ribs on the seal members 16a, 16b are preferred, other shapes can be used as long as they provide a fluid tight seal. It is believed preferable, however, that the male projections of the seal members have an enlarged distal end and that the female receptacles or grooves formed between the male projections have an opening that is smaller than the enlarged distal ends in order to provide resistance to separating the joined seal members 16a, 16b.

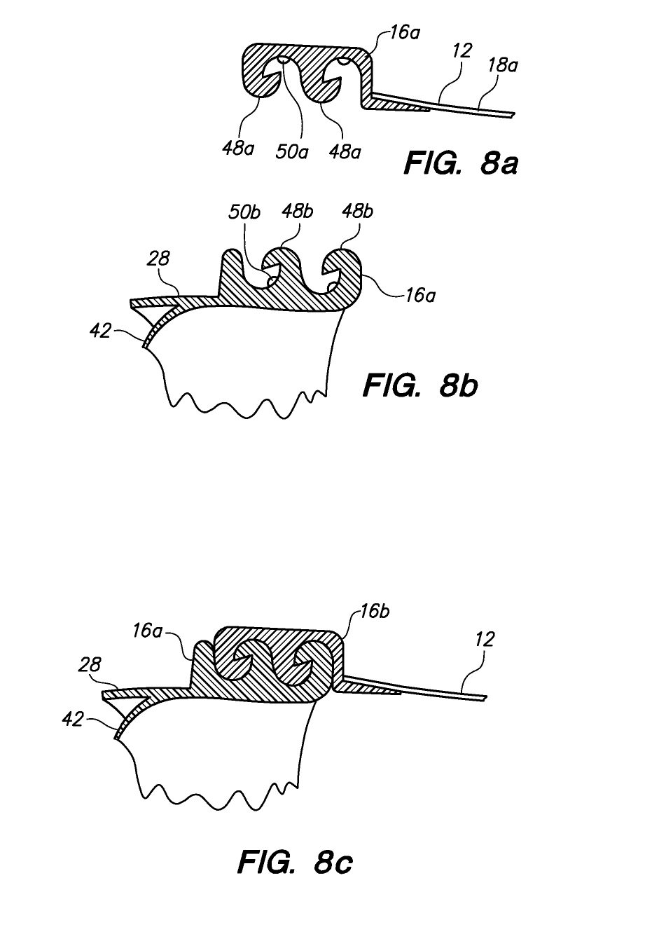

Referring to FIGS. 8a-8b, optionally, the ribs 48a and 48b of the seal members 16a, 16b are formed of a first harder polymeric material and gaskets 50a, 50b are integrally formed on the ribs or in the bottom of the recesses between the ribs, and formed out of a second softer polymeric material. The gaskets 50a and 50b are substantially compressed when the seal members 16a, 16b are joined. This compression provides a moisture-resistant seal between the ribs 48a and 48b and the juxtaposed channels. The gaskets 50a, 50b could also be formed at various locations on the channels or ribs on either of the seal parts 16a, 16b.

Preferably the seals 16a, 16b are made of extruded segments or lengths of material, which are cut to the desired length and glued end-to-end to form rings, with the ends of the rings being adhered or otherwise bonded together. The ends of extruded strips 16a, 16b could also be joined by sonic or radio frequency welding. Alternatively, the seals 16a, 16b could be integrally molded of one piece of material in a ring shape and fastened to the respective hood 12 or face mask 26. The seals 16a, 16b could also be formed by extrusion processes and then cut to length and then glued, bonded or otherwise fastened to the hood or mask. Advantageously, the seals 16a, 16b are integrally molded with the strips 18a, 18b to facilitate fastening the seals to their respective parts. One suitable fastener for use in fabricating the seal members 16a, 16b is disclosed in U.S. Pat. No. 5,351,369 of Swain, the complete contents of which is hereby incorporated by reference. These fasteners are made of extruded, flexible polymeric materials and are commercially available under the trademark U-Maxigrip. Further, while the seal members 16a, 16b are shown with three hooks and three gaskets, any suitable number of hooks and/or gaskets can be used.

While the use of three ribs and three gaskets are believed suitable, it is also believed that simpler seals can be used. In particular, the use of two hooked portions 48a and 48b with mating channels are believed suitable, even without gaskets 50a and 50b. Further, ribbed seals, including seals with such mating hooks and channels may be made of polyurethane, natural rubber, synthetic rubbers or other elastomeric materials. Materials with a duromerter of about 70 are believed suitable, such that both mating parts 16a, 16b may be made of the same material. Of course, the materials used in the mask 26, seals 16a, 16b and hood 12 may be selected depending upon the environment in which they are used and the material to be excluded from the suit 10 by the seals 16a, 16b.

Referring to FIG. 6 the face mask 26 preferably has a skirt 42 attached to the inner periphery of the face mask and extending inward relative to the face mask away from the seal 16b. The skirt 42 is usually made of the same material as the face mask body 28 and molded as a unitary part as the body 28, but formed to be much thinner and more flexible. Thus, if the body 28 is made of butyl rubber the skirt is made of butyl rubber and both are formed or molded at the same time as a unitary part. If the body 28 is made of silicon the skirt is made of silicon. A skirt an inch or two wide is commonly used. The skirt 42 abuts portions of the user's face to form a contact seal or friction seal with the user's face. The pressure forming the seal is provided by the head harness 37 via the attachments 36 and straps 38.

An oral-nasal mask 41 is shown in cross-section in FIGS. 6-7, with flexible skirts 43 around the user's nose and mouth configured and sized to be held to the user's face around the mouth and nose by the head harness 37 and its connectors 36 and straps 38 described herein. Depending on the manufacturer, the skirt 42 may abut the user's face or both the face and a portion of the full face mask body 28 or its skirt 42. The head harness 37 and its connectors 36 and straps 38 are advantageously secured sufficiently to provide a gas tight seal for the oral-nasal mask 41, and preferably also provide sufficient force to the full face mask 26 to provide a fluid seal through the contact seal or friction seal around the inner periphery of the mask provided by pressing the skirt 42 against the user's face. The harness 37 and its connectors 36 and straps 38 may or may not assist in maintaining the seal members 16a, 16b in sealing engagement, but preferably help maintain the seal members in sealing engagement. Thus, the harness 37 and its straps 38 and connectors 36 provide or help provide at least one seal around the oral-nasal mask 41, may provide or help provide a second seal around the inner periphery of the full face mask 26 through the skirt 42, and may provide or help provide a third seal around the periphery of the full face mask 26 through urging the seal members 16a, 16b into contact or helping them remain in contact. The full face mask 26 thus also has three seals, one by the skirt around oral-nasal mask 41, a second by the skirt 42 around the inner periphery of the mask 26, and a third by the mating ribs of the mating seal members 16a, 16b.

Referring to FIG. 7, the hood 12 is advantageously formed of a single piece of material with the suit 10 or at least formed of a single piece with the torso portion of the suit 10. If desired, however, the hood 12 can be removably attached to the suit 10 using an outer closure 56, a portion of which is shown in FIG. 5.

The seals 16a, 16b and any associated marginal strips 18a, 18b may also be integrally extruded from or molded of a first polymeric material preferably having a hardness in the range of from about 60 durometer to about 95 durometer. The gaskets 50a and 50b may be co-extruded or molded out of a second polymeric material compatible for the purposes of co-extrusion and bonding with the first polymeric material. The second polymeric material preferably has a hardness in the range of about 20 durometer to about 55 durometer. The first polymeric material may be low to medium density polyethylene, or polypropylene or polyurethane. The second polymeric material may be thermoplastic rubber, styrene ethylene butydene styrene block copolymer. One suitable adhesive for gluing these commercially available fasteners end-to-end is UPACO 0406, commercially available from the Adhesive Division of Workmen Industries of Nashua, N.H. Preferably a primer is applied to the plastic fastener before adhesive bonding of the abutting ends, one suitable primer being UPACO 3244B. Preferably though, the seals 16a, 16b are both molded of silicon rubber or butyl rubber and fastened to the face mask 26, while the skirt 42 is integrally and simultaneously molded with the face mask 26.

The suit 10 advantageously provides with the hood 12 and full face mask 26 and gloves advantageously covers the entire body and seals it from contact with the environment outside the suit. Suitable suits are described in U.S. Pat. Nos. 6,415,440 and 7,062,786, the complete contents of which are incorporated herein by reference. Briefly, the suit 10 includes

The suit body 10 and hood 12 could be made of any fabric suitable for the intended use. Above water HAZMAT suits may have different requirements than underwater suits. For underwater suits the fabric is waterproof. Many suitable materials for both HAZMAT and underwater suits are known and available. The suit 10 and hood 12 may also be made of a range of films and/or coatings used in combination with textiles for strength. The coatings could be a range of natural or synthetic rubber, while laminate films range from polypropylene, polyethylene, GORTEX® fabric or TEFLON®, etc. Suitable waterproof zippers for use on the suit 10 or connecting hood 12 to a suit 10 are commercially available from YKK, New Zipper Company or Dynet.

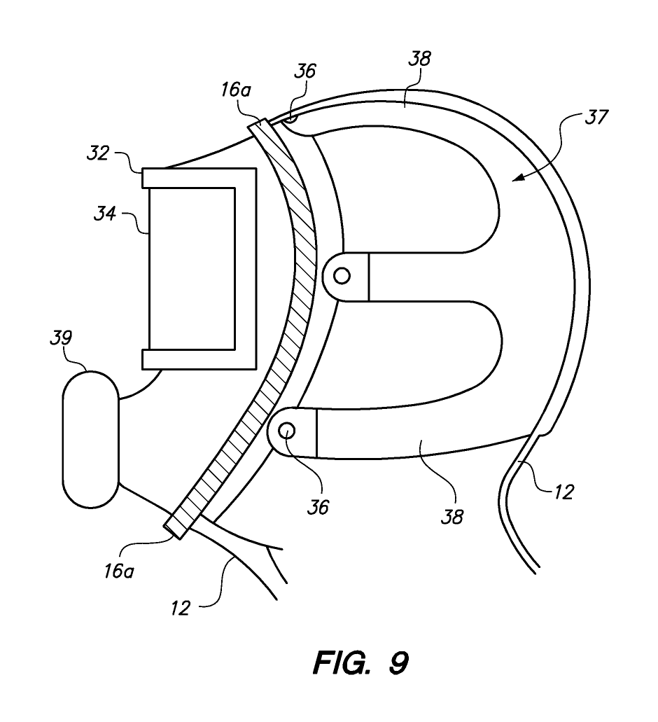

Referring to FIG. 7, the head harness 37 is shown with the harness on the outside of the hood 12. As shown in FIG. 9, in some cases it is advantageous to place the harness 37 and associated connectors 36 and straps 38 inside the hood. In such instances the connectors 36 are fastened to the outside of the mask body 28 at or adjacent to the periphery of the body, with the mask seal 16b located further away from the periphery so the connectors 36 are between the seal 16b and the periphery of the mask body. Usually the connectors 36 are located within the first inch or two of the periphery of the mask body 28. The periphery of the mask body 28 could extend outward from the body 28 in the localized area of the connectors 36 (e.g., on tabs) in order to bring the seal 16b closer to the majority of the periphery of the mask body, but that is not preferred. The seal 16b is located forward of the connectors 36 rather than rearward of the connectors. Placing the harness 37 and associated connectors 36 and straps 38 inside the hood avoids removing contaminants from the complex shaped surfaces of the connectors and provides a more streamlined exterior surface on the hood. It also avoids the risk of branches snagging on the harness, straps or connectors and any attendant compromising of the seal between the mask and the hood.

There are also provided several improved methods which make use of the facemask and seals 16a, 16b. The method may include engaging the ribs 48b on the ribbed mask seal 16b with the ribs 48a on the ribbed hood seal 16a to form a fluid tight seal. The harness 37 is placed to encircle at least a portion of the user's head, and the facemask is fastened to the harness 37 so that the harness holds at least a portion of the facemask against the user's head or hood.

In the configuration shown in FIG. 7 the facemask seals against the user's face using skirt seal 42 while the facemask also seals against the hood 12 using ribbed seal members 16a, 16b. In this configuration there are two seals, one formed with the user's face and the other formed with the hood over the user's head.

In the configuration shown in FIG. 9, the facemask seals against the hood using skirt seal 42 and also seals to the hood using ribbed seal members 16a, 16b. Thus, there are two seals with the hood, one formed by facemask skirt 42 abutting the user's face and the other by ribbed seal members 16a, 16b. The method includes connectors 36 on an outer surface of the facemask and located forward of the second seal 16b and between the second seal and a viewing visor 34 of the facemask. The method includes fastening the facemask to the user's head with the harness located outside of the hood 12.

The method may also include locating the fasteners 36 on an outer surface of the facemask and located between the second seal 16b and a periphery of the facemask so as to connect to a harness placed inside of the hood 12. The method then further includes: fastening the facemask to the user's head with the harness inside the hood. In both methods the skirt seal 42 provides a first seal between the mask and the user's face, and the sealing members 16a, 16b provide a second seal between the facemask and the hood. The seal provided by the skirt 42 between the facemask and user's face is advantageously at least a gas seal and preferably a fluid tight seal. The seal provided by the seal members 16a, 16b is preferably a fluid tight seal.

The material used to make the hood 26 and the remainder of the body suit 10 may be waterproof, or may allow water to pass while blocking the passage of one or more gasses. For HAZMAT suits, it may be useful in some applications to bar the passage of liquids and allow the passage of air in order to keep the user cooler. In diving applications or where HAZMAT applications involve gases, it is useful to use a material that is waterproof and that does not allow the passage of gases.

What is claimed is:

1. A face mask assembly, the facemask having a body portion with an outer periphery shaped to abut and conform to a user's head or a hood covering that head, the body portion having a viewing visor and during use a head harness to hold the mask against the user's head or hood, the assembly comprising:
a first ribbed seal member connected to and extending completely around the outer periphery of the mask and located on an outward facing surface of the mask;
a first skirt connected to the mask and extending completely around the outer periphery of the mask, the first skirt extending along a portion of the inside surface of the mask during use and configured to form a contact seal with the user's head or hood when the harness is sufficiently tightened during use of the mask;
at least two connectors on the mask configured to connect the mask to the harness during use of the mask.

2. The face mask assembly of claim 1, where in the mask is a full face mask with a top, two opposing sides and a bottom, the bottom being configured and located relative to the top to abut a user's neck during use.

3. The face mask assembly of claim 2, further comprising:
an oral-nasal mask contained at least partially within the full face mask, the oral-nasal mask having a second flexible skirt around a periphery of the oral-nasal mask which second skirt extends along an inside portion of the oral-nasal mask and is configured to form a contact seal with the user's face during use.

4. The face mask assembly of claim 1, wherein there are from three to five connectors.

5. The face mask assembly of claim 1, wherein the connectors are located on the outer surface of the mask and between the ribbed seal member and the viewing visor.

6. The face mask assembly of claim 1, wherein the connectors are located on the outer surface of the mask and between the ribbed seal member and the outer periphery of the mask.

7. The face mask assembly of claim 1, further comprising:
a flexible hood configured to fit over and generally conform to the shape of the user's head and neck during use, the hood having a face opening with a second ribbed seal member extending completely around a periphery of the face opening, the second ribbed seal member located on an inward facing surface of the hood and sized and configured and located to mate with the first seal member to form a fluid tight seal.

8. The face mask assembly of claim 1 wherein the mask is a partial face mask with a top, two opposing sides and a bottom, the bottom being configured and located relative to the top abut a user's face between the nose and mouth during use.

9. The face mask assembly of claim 8, further comprising:
a flexible hood configured to fit over and generally conform to the shape of the user's head and neck during use, the hood having a face opening with a second ribbed seal member extending completely around a periphery of the face opening, the second ribbed seal member located on an inward facing surface of the hood and sized and configured and located to mate with the first seal member to form a fluid tight seal, the face opening having at op, bottom and sides with the bottom of the face opening located and configured to abut the user's face between the nose and mouth during use.

10. The face mask assembly of claim 1, wherein the first seal member has three hooked ribs.

11. The face mask assembly of claim 7, wherein the first and second ribbed seal members each have at least two hooked ribs.

12. The face mask assembly of claim 9, wherein the first and second ribbed seal members each have at least two hooked ribs.

13. An assembly for use with a facemask having a body portion with an outer periphery shaped to abut and conform to the shape of a hood covering a user's head during use, the body portion having a viewing visor and during use a head harness to hold the mask against the user's head, the assembly comprising:
a flexible hood configured to conform to and fit over the user's head during use, the hood having a face opening with a periphery and a first ribbed seal member connected to the hood and extending completely around that periphery, the first seal member being on an inward facing surface of the hood.

14. The assembly of claim 13, wherein the face opening has a top, opposing sides and a bottom opposite the top, with the top and bottom being sized and located relative to each other so that the top is at the user's forehead during use and the bottom is located at the user's neck.

15. The assembly of claim 13, wherein the face opening has a top, opposing sides and a bottom opposite the top, with the top and bottom being sized and located relative to each other so that the top is at the user's forehead during use and the bottom is located to fit between the user's nose and mouth during use.

16. The assembly of claim 13, further including a mask, comprising:
a second ribbed seal member connected to and extending completely around the outer periphery of the mask and located on an outward facing surface of the mask, the first and second seal members being sized and configured and located to mate with each other and form a fluid tight seal during use;
a first flexible skirt connected to the mask and extending completely around the outer periphery of the mask, the first skirt extending along a portion of the inside surface of the mask during use and configured to form a contact seal with the user's head or hood when the harness is sufficiently tightened during use of the mask;
a plurality of connectors on the mask configured to connect the mask to the harness during use of the mask.

17. The assembly of claim 14, further including a mask, comprising:
a second ribbed seal member connected to and extending completely around the outer periphery of the mask and located on an outward facing surface of the mask, the first and second seal members being sized and configured and located to mate with each other and form a fluid tight seal during use;
a first skirt connected to the mask and extending completely around the outer periphery of the mask, the first skirt extending along a portion of the inside surface of the mask during use and configured to form a contact seal with the user's head or hood when the harness is sufficiently tightened during use of the mask;
a plurality of connectors on the mask configured to connect the mask to the harness during use of the mask, the connectors being located on the outer surface of the mask and between the ribbed seal member and the viewing visor.

18. The assembly of claim 15, further including a mask, comprising:
a second ribbed seal member connected to and extending completely around the outer periphery of the mask and located on an outward facing surface of the mask, the first and second seal members being sized and configured and located to mate with each other and form a fluid tight seal during use;
a first skirt connected to the mask and extending completely around the outer periphery of the mask, the first skirt extending along a portion of the inside surface of the mask during use and configured to form a contact seal with the user's head or hood when the harness is sufficiently tightened during use of the mask;
a plurality of connectors on the mask configured to connect the mask to the harness during use of the mask, the connectors being located on the outer surface of the mask and between the ribbed seal member and the viewing visor.

19. The assembly of claim 13, wherein the first and second seal members are joined together to form a fluid tight seal.

20. The assembly of claim 16, wherein the first and second seal members are joined together to form a fluid tight seal.

21. The assembly of claim 17, wherein the first and second seal members are joined together to form a fluid tight seal.

22. The assembly of claim 18, wherein the first and second seal members are joined together to form a fluid tight seal.

23. The assembly of claim 19, further comprising a body suit sealingly connected to the hood, the body suit, enclosing the user's body except the head and face, with the hood and face shield enclosing the head and face.

24. The face mask assembly of claim 13, wherein the connectors are located on the outer surface of the mask and between the ribbed seal member and the viewing visor.

25. The face mask assembly of claim 13, wherein the connectors are located on the outer surface of the mask and between the ribbed seal member and the outer periphery of the mask.

26. A method for sealing a full facemask to a hood sized to fit over a user's head, the hood having an open viewing port located at the user's eyes with a first ribbed hood seal encircling the port, the full facemask having a periphery with a second, ribbed mask seal encircling the periphery adjacent to the periphery, the method comprising:
engaging the ribs on the ribbed mask seal with the ribbed hood seal to form a fluid tight seal between the facemask and the hood; and
fastening the facemask to a harness encircling a portion of the user's head so that the harness holds a portion of the facemask against the user's head or hood.

27. The method of claim 26, wherein the facemask has a flexible skirt around the periphery of the facemask, and further comprising urging that skirt against the user's face to form at least a gas tight seal.

28. The method of claim 27, wherein the harness includes connectors on an outer surface of the facemask and located between the second seal and a periphery of the facemask, and further comprising:
fastening the facemask to the user's head with the harness inside the hood.

29. The method of claim 28, wherein the harness includes connectors on an outer surface of the facemask and located forward of the second seal and between the second seal and a viewing visor of the facemask, and further comprising:
fastening the facemask to the user's head with the harness located outside of the hood.
